(19) United States
(12) Patent Application Publication
(10) Pub. No.: US 2019/0264426 A1
(43) Pub. Date: Aug. 29, 2019

(54) Arrangement and Method for Obtaining Water from a Humid Gas Mixture

(71) Applicant: Siemens Aktiengesellschaft, Muenchen (DE)

(72) Inventors: Gerhard Zimmermann, Höchstadt/Aisch (DE); Markus Ungerer, Baiersdorf (DE)

(73) Assignee: Siemens Aktiengesellschaft, Muenchen (DE)

(21) Appl. No.: 16/320,224

(22) PCT Filed: Jul. 18, 2017
(86) PCT No.: PCT/EP2017/068132

§ 371 Date: Jan. 24, 2019

(30) Foreign Application Priority Data
Jul. 25, 2016 (DE) 10 2016 213 570.8

(51) Int. Cl. E03B 3/28; B01D 53/26; F04F 13/00; F25B 27/00

(52) U.S. Cl. CPC E03B 3/28; F25B 27/00; F04F 13/00; B01D 53/265

(57) ABSTRACT

Various embodiments include a device for extracting water from a humid gas mixture at a first temperature comprising: a compressor to compress the mixture from a first pressure to a second pressure at which the dew point of the mixture lies above the first temperature; a pressure vessel receiving the mixture at the second pressure and condensing out a first fraction of water; a pressure exchanger operable to transfer the second pressure from the gas mixture after removing the first fraction of water to a fresh feed of the gas mixture; and lines connecting the pressure exchanger and the pressure vessel in such a way that the fresh feed at the second pressure can be guided from the pressure exchanger into the pressure vessel, and the gas mixture with the reduced water content can be guided from the pressure vessel into the pressure exchanger.

### CROSS-REFERENCE TO RELATED APPLICATIONS

This application is a U.S. National Stage Application of International Application No. PCT/EP2017/068132 filed Jul. 18, 2017, which designates the United States of America, and claims priority to DE Application No. 10 2016 213 570.8 filed Jul. 25, 2016, the contents of which are hereby incorporated by reference in their entirety.

### TECHNICAL FIELD

The present disclosure relates to generating water. Various embodiments may include arrangements and methods for extracting water from a humid gas mixture.

### BACKGROUND

In some regions of the world, there is already too little drinking water available nowadays. This problem will increase considerably in the coming years. The reasons for this are not only climate change but also population and economic growth. By 2020, the water requirement will probably increase by 40%.

One possibility of generating drinking and service water in coastal vicinities lies in the desalination of seawater. Drinking and service water is usually generated from seawater by means of reverse osmosis. However, this technology generates large amounts of salt-rich concentrate as waste. This salt-rich concentrate is frequently disposed of by being fed into the sea, where it causes serious environmental damage.

One possible alternative for water extraction, in particular for drinking water extraction, lies in extracting water from the air. In the case of extracting water from air, it is known practice to cool a surface to below the dew point of the air using an electrically operated refrigerating machine. The water condenses out of the air below the dew point and can thus be recovered. This technique has the disadvantage of high energy consumption. Even with a refrigeration recovery device or a precooling of the incoming air flow, the energy consumption of this water extraction method is disadvantageously high.

### SUMMARY

The teachings of the present disclosure describe methods and arrangements which allow water to be extracted from air in an energy-efficient manner. For example, some embodiments include an arrangement (1) for extracting water (32) from a humid gas mixture (30) at a first temperature, comprising: a compressor device (3) suitable for compressing the gas mixture (30) from a first pressure (P1) to a second pressure (P2) at which the dew point of the gas mixture lies above the first temperature, a pressure vessel (2) for receiving the gas mixture (31) and condensing out at least a first fraction of the water from the gas mixture (31) in the pressure vessel (2), a pressure exchanger (4) suitable for transferring the second pressure (P2) from the gas mixture with reduced water content (35) to a fresh feed (36) of the gas mixture, wherein the pressure exchanger (4) and the pressure vessel (2) are connected to one another via lines in such a way that the fresh feed (36) at the second pressure (P2) can be guided from the pressure exchanger (4) into the pressure vessel (2), and the gas mixture with the reduced water content (34) can be guided from the pressure vessel (2) into the pressure exchanger (4).

In some embodiments, the pressure vessel (2) comprises a heat exchanger with a first surface which is suitable for transporting the condensation heat (33) out of the pressure vessel (2) into the surroundings.

In some embodiments, the pressure exchanger (4) is a cell-ring pressure exchanger or a rotary pressure exchanger.

In some embodiments, the compressor device is a wind wheel and/or an electrically operated compressor (3).

As another example, some embodiments include a method for extracting water (32) from a gas mixture at a first temperature (30), comprising: compressing a gas mixture (30) from a first pressure (P1) to a second pressure (P2) at which the dew point of the gas mixture (31) lies above the first temperature, guiding the gas mixture (31) into a pressure vessel (2), condensing out at least a first fraction of the water (32) from the gas mixture (31) in the pressure vessel (2), guiding the gas mixture with reduced water content (34) at the second pressure (P2) into a pressure exchanger (4), transferring the second pressure (P2) from the gas mixture with reduced water content (34) to a fresh feed of the gas mixture (30) in the pressure exchanger (4), and guiding the fresh feed of the gas mixture (36) at the second pressure (P2) into the pressure vessel (2).

In some embodiments, the first temperature lies in a range from 5° C. to 60° C.

In some embodiments, the second pressure (P2) lies in a range from 1 bar to 30 bar.

In some embodiments, the gas mixture is compressed in a wind wheel by means of wind energy or electrically.

In some embodiments, the pressure vessel (2) is cooled with ambient air.

### BRIEF DESCRIPTION OF THE DRAWINGS

Further embodiments and further features of the teachings herein are explained in further detail by way of the following figures. These are exemplary embodiments and combinations of features which do not signify any limitation of the scope of the teachings.

In the figures:

FIG. 1 shows a water extraction system incorporating the teachings of the present disclosure and having a pressure vessel, a compressor, and a pressure exchanger; and

FIG. 2 shows an overview of an example method for water extraction incorporating teachings of the present disclosure.

### DETAILED DESCRIPTION

In some embodiments, a device for extracting water from a humid gas mixture at a first temperature comprises a compressor device which is suitable for compressing the gas mixture from a first pressure to a second pressure at which the dew point of the gas mixture lies above the first temperature. Furthermore, the device comprises a pressure vessel for receiving the gas mixture at the second pressure and for condensing out at least a first fraction of the water from the gas mixture in the pressure vessel. Furthermore, the device comprises a pressure exchanger which is suitable for transferring the second pressure from the gas mixture with reduced water content to a fresh feed of the gas mixture. The pressure exchanger and the pressure vessel are connected to one another via lines in such a way that the fresh feed at the second pressure can be guided from the pressure exchanger into the pressure vessel, and the gas mixture with the reduced water content can be guided from the pressure vessel into the pressure exchanger.

In some embodiments, a method for extracting water from a humid gas mixture at a first temperature comprises, on the one hand, compressing the gas mixture from a first pressure to a second pressure at which the dew point of the gas mixture lies above the first temperature. The gas mixture is then guided into a pressure vessel. At least a first fraction of the water is condensed out from the gas mixture in the pressure vessel, with the result that at least a first fraction of water is extracted from the gas mixture. Furthermore, the gas mixture with the reduced water content is guided at the second pressure into a pressure exchanger. In the pressure exchanger, the second pressure from the gas mixture with reduced water content is transferred to a fresh feed of the gas mixture in the pressure exchanger. The fresh feed of the gas mixture at the second pressure is then guided into the pressure vessel.

Up until now, energy recovery was carried out after dehumidifying the gas mixture in that the dehumidified gas mixture was expanded through the use of a turbine and electrical energy was produced by a generator. Water extraction then in turn required the same amount of fresh humid gas mixture to be compressed by the compressor. By using a pressure exchanger, the method for compressing the gas mixture may be improved in terms of energy. The dehumidified gas mixture releases the pressure to the fresh feed of the gas mixture, with the result that the fresh feed can be guided at a higher pressure back into the pressure vessel. The pressure exchanger operates with an efficiency in a range of 96-98% and is thus significantly more efficient by comparison with the use of a turbine or a generator for recovering the pressure energy (efficiencies of about 80%). Only a small amount of fresh gas mixture, which replaces the separated-off water and compensates for the small energy losses in the pressure exchanger, is compressed by means of the compressor device.

Furthermore, a situation may be avoided in which the temperature of the gas mixture has to be cooled under ambient temperature by means of refrigerating machines in order to fall below the dew point. Refrigerating machines frequently have a lower efficiency on account of ice layers which form on the condenser, since insulation effects diminish the further condensation process.

In some embodiments, the pressure vessel comprises a heat exchanger with a first surface suitable for transporting the condensation heat into the surroundings. The condensation heat may be transported away into the surroundings by means of ambient air. The heat exchanger in the pressure vessel then has to have a sufficiently large surface in order to allow an efficient heat exchange with the cooling medium air. A better control of the temperature distribution in the pressure vessel can be ensured with a cooling with ambient air at the increased second pressure in the pressure vessel by comparison with a cooling with a refrigerating machine at ambient pressure.

In some embodiments, the pressure exchanger is a cell-ring pressure exchanger or rotary pressure exchanger. The efficiencies of these pressure exchangers may lie in a range from 96-98%. Pressure exchangers in this document designate a device which is suitable for carrying out a virtually isobaric energy transfer in pressure-operated processes. In some embodiments, it is possible by means of pressure exchangers for the pressure energy of a liquid stream or gas stream that has remained after passing through a process to be transferred to the feed stream and thus to be recovered. In the case of pressure exchangers as are used here, the energy transfer is carried out while maintaining the hydraulic pressure. In technical terms, this occurs by spatial displacement in pressure pipes. The gas mixture under the second high pressure with the reduced water content transfers the pressure to the fresh feed gas mixture in a pressure pipe. A displaceable barrier, in particular a barrier fluid or a piston, prevents mixing of the two gas mixtures. The use of high- and low-side valves then allows the high-pressure side and low-pressure side to be alternately connected.

Continuous transport and pressure equalization when switching from high to low pressure can be optimized by means of a plurality of pressure pipes. In a rotary exchanger, it is possible to transfer the energy in a particularly efficient manner. In a rotary pressure exchanger there is arranged a cylindrical rotor which comprises bores parallel to the rotor axis. The gas mixture with the reduced water content enters at the high second pressure into the rotary exchanger at one end and transfers the pressure directly to the fresh feed gas mixture stream at a low pressure at the other end of the rotor. A displaceable barrier, e.g. a barrier fluid or a piston, prevents mixing of the two gas mixtures. The connection lines are in each case alternately opened and closed on both sides by the rotation of the rotor. In an intermediate position, the rotary pressure exchanger closes both ends, and thus performs the function of valves.

In some embodiments, the first temperature lies in a range from 5° C. to 60° C., e.g. from 15° C. to 45° C. The water condenses out at ambient temperatures. Therefore, the dew point should lie above the first temperature.

In some embodiments, the pressure lies in a range from 1 bar to 30 bar, in particular in a range from 1 bar to 10 bar. The pressure must typically be increased in such a way that the dew point lies below the prevailing pressure. The minimum pressures can thus be determined on the basis of the dew point curve.

In some embodiments, the compressor device is driven via a wind wheel or is integrated into a wind wheel. The gas mixture is then compressed in a wind wheel by means of wind energy. The wind energy can be directly used by a wind wheel in order to compress the ambient air. When converting the rotational energy of a wind wheel into electricity, efficiencies of approximately 70% are customary. In addition, losses occur with a compressor driven by electricity. These losses can be significantly reduced. Ambient air is typically sucked in at the center of the wind wheel and compressed in a pressure-resistant pipe by means of the wind energy captured over the entire rotor cross section of the wind wheel. The pressure-resistant pipe can extend from the center of the wind wheel in the middle of the rotor blades to the bottom of the wind mast at the ground surface. The heat which arises during the condensation of the water can be removed at the surface of the pressure-resistant pipe.

In some embodiments, the compressor device is an electrically operated compressor. In such embodiments, only the fraction is compressed that leaves the pressure vessel on account of the condensation of the water and is not guided through the pressure exchanger. Pressure losses in the pressure exchanger can also be compensated for as a result. Energy may thus be saved during the water extraction.

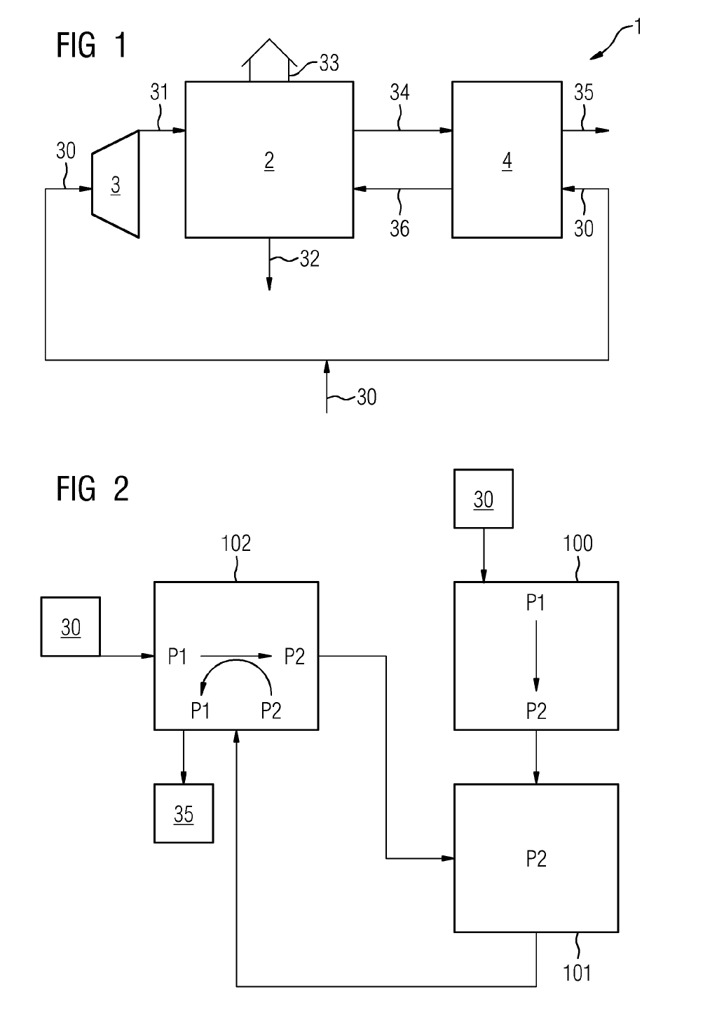

FIG. 1 shows a water extraction system 1 having a pressure vessel 2, an electrical compressor 3, and a pressure exchanger 4. A humid feed gas mixture 30 is guided at a first pressure P1 into the compressor 3. The humid feed gas mixture is compressed to a second pressure P2 in the compressor 3. The humid gas mixture 30 may be air or a humid exhaust gas. In this example, the feed gas mixture is air. The air 30 compressed to a second pressure P2 is then guided into a pressure vessel 2. The water condenses out of the humid air in the pressure vessel 2. The water 32 can then be guided out of the pressure vessel 2. The condensation heat 33 can be released into the surroundings via a heat-exchange device. The pressure vessel 2 may be cooled with ambient air. In this case, the pressure vessel 2 comprises cooling ribs in order to make the surface available for heat exchange as large as possible. The dehumidified gas mixture, that is to say the dehumidified air 34, is guided at the second pressure P2 into the pressure exchanger 4. A fresh feed gas mixture 30 is also guided into the pressure exchanger 4. The pressure transfer of the second pressure P2 from the dehumidified air 34 to the feed mixture air 30 then takes place in the pressure exchanger 4. The feed gas mixture air 36 then leaves the pressure exchanger 4 at a second pressure P2 to pass into the pressure vessel 2. The dehumidified gas mixture air 34 leaves the pressure vessel 2. Only the fraction of the gas mixture which has been condensed out as water 32 and the pressure losses over the pressure exchanger must be compressed in the compressor to the second pressure. In some embodiments, the compressor device can be a wind wheel.

In some embodiments, the temperature of the ambient air is 27° C. with a relative air humidity of 60%. The water content of the air is then 13 g_{water}/kgₐᵢᵣ. The water content of the air is intended to be dried to a content of 7 g_{water}/kgₐᵢᵣ by means of the method for extracting water. For this purpose, the pressure must be raised from 1 bar to 4 bar. With a compressor efficiency of 80%, a work of 0.05 kWh per liter of produced drinking water should be applied for the water fraction in the air. An efficiency of 96% can be expected for the losses of the pressure exchanger, with the result that 0.22 kWh per liter of produced drinking water should be applied. There thus results a total energy of 0.27 kWh per liter of produced drinking water in this example. In the case of slightly better climate conditions, that is to say more humid air at higher temperature, values of below 0.2 kWh per liter of produced drinking water are also possible. This means that the method is as energy-efficient as methods for water extraction from air that are already used in the prior art.

FIG. 2 shows an example method for water extraction from air. The feed gas mixture air is introduced at a first pressure P1 into the compressor 3 for compression to a second pressure P2. This step occurs as step 100. In a following step 101, the water 32 condenses out of the gas mixture at the second pressure in the pressure vessel 2. The dehumidified gas mixture 34 is subsequently guided into a pressure exchanger 4. The pressure exchange 102 takes place in the pressure exchanger 4. Here, the second pressure P2 from the dehumidified gas mixture air 34 is transferred to a fresh feed gas mixture 30. In this case, the pressure of the dehumidified gas mixture is reduced from the second pressure P2 to the first pressure P1, whereas the fresh feed gas mixture 30 is increased from a first pressure P1 to a second pressure P2 and can be guided into the condensing-out step 101. The dehumidified gas mixture 35 is removed from the process after the pressure exchange 102.

What is claimed is:

1. A device for extracting water from a humid gas mixture at a first temperature, the device comprising:
a compressor operable to compress the gas mixture from a first pressure to a second pressure at which the dew point of the gas mixture lies above the first temperature;
a pressure vessel for receiving the gas mixture at the second pressure and condensing out a first fraction of water from the gas mixture;
a pressure exchanger operable to transfer the second pressure from the gas mixture after removing the first fraction of water to a fresh feed of the gas mixture; and
lines connecting the pressure exchanger and the pressure vessel in such a way that the fresh feed at the second pressure can be guided from the pressure exchanger into the pressure vessel, and the gas mixture with the reduced water content can be guided from the pressure vessel into the pressure exchanger.

2. The device as claimed in claim 1, wherein the pressure vessel comprises a heat exchanger with a first surface transporting the condensation heat out of the pressure vessel into the surroundings.

3. The device as claimed in claim 1, wherein the pressure exchanger comprises a cell-ring pressure exchanger or a rotary pressure exchanger.

4. The device as claimed in claim 1, wherein the compressor device comprises at least one selected from the group consisting of: a wind wheel and an electrically operated compressor.

5. A method for extracting water from a gas mixture at a first temperature, the method comprising:
compressing the gas mixture from a first pressure to a second pressure at which a dew point of the gas mixture lies above the first temperature;
delivering the gas mixture at the second pressure into a pressure vessel;
condensing out a first fraction of the water from the gas mixture at the second pressure in the pressure vessel;
delivering the gas mixture with reduced water content at the second pressure into a pressure exchanger;
transferring the second pressure from the gas mixture with reduced water content to a fresh feed of the gas mixture in the pressure exchanger; and
guiding the fresh feed of the gas mixture at the second pressure into the pressure vessel.

6. The method as claimed in claim 5, wherein the first temperature lies in a range from 5° C. to 60° C.

7. The method as claimed in claim 5, wherein the second pressure lies in a range from 1 bar to 30 bar.

8. The method as claimed in claim 5, wherein compressing the gas mixture includes using a wind wheel or electrical compression.

9. The method as claimed in claim 5, further comprising cooling the pressure vessel with ambient air.
